(19) United States
(12) Patent Application Publication
(10) Pub. No.: US 2023/0182555 A1
(43) Pub. Date: Jun. 15, 2023

(54) FRAMELESS DOOR FOR VEHICLE

(71) Applicants: Hyundai Motor Company, Seoul (KR); Kia Corporation, Seoul (KR); HWASEUNG R&A CO., LTD, Yangsan (KR)

(72) Inventors: Hyeong Geun Jo, Suwon (KR); You Chan Park, Ansan (KR); Young Uk Yun, Suwon (KR); Hoo Sang Park, Hwaseong (KR); Jin Hyung Bae, Yangsan (KR); Ji Yun Cha, Yangsan (KR)

(21) Appl. No.: 17/968,145

(22) Filed: Oct. 18, 2022

(30) Foreign Application Priority Data
Dec. 15, 2021 (KR) 10-2021-0179815

(51) Int. Cl. B60J 10/777; B60J 10/76

(52) U.S. Cl. CPC B60J 10/777; B60J 10/76

(57) ABSTRACT

A frameless door for a vehicle is provided. The frameless door includes a fixed glass coupled to a door frame of a vehicle, an elastic member mounted to enclose an upper edge of the fixed glass, a glass run arranged between the fixed glass and a moving glass, and configured to guide upward movement of the moving glass, and configured to seal an inside space of the moving glass, and a division channel configured to accommodate the glass run therein, and configured to fix both the fixed glass and the glass run to the door frame.

### CROSS REFERENCE TO RELATED APPLICATION

The present application claims under 35 U. S. C. § 119(a) the benefit of Korean Patent Application No. 10-2021-0179815, filed Dec. 15, 2021, the entire contents of which is incorporated herein for all purposes by this reference.

### TECHNICAL FIELD

The present disclosure relates generally to a frameless door for a vehicle and, more particularly, to a frameless door for a vehicle, wherein a glass run is separately manufactured so as to be movable in contact with a moving glass and the form of an inner lip supporting an inner surface of the moving glass is changed so as to improve watertight performance.

### DESCRIPTION OF THE RELATED ART

Generally, a body of a vehicle is equipped with a door that is rotatably opened and closed by means of a hinge for an occupant to board the vehicle. The door includes a door glass that selectively opens the indoor space by moving upward and downward by a door regulator.

The type of the door may be divided into a frame-structure door in which a frame supports the door glass and a frameless door having a structure in which the door glass raised and lowered is supported by a panel provided in the vehicle body without using a frame.

More particularly, in the frameless door, the door glass has a structure in which the door glass is brought into contact with a door weather strip in sealing of the door, so that airtightness between the door and the vehicle part is maintained.

Meanwhile, in a vehicle with the frameless door, a fixed glass part may be securely mounted to not only a rear door, but also a front door. The fixed glass is integrally mounted to one portion of a division channel.

However, in a case of vehicles equipped with the frameless door that are recently released, a futuristic design is realized by eliminating a step difference between the fixed glass and the door glass and making the fixed glass and door glass look like one part. However, in case of rain, car washing, etc., there is a problem in that water flows into the vehicle room through the periphery of the fixed glass, more specifically, through a gap between the door glass and the fixed glass.

### SUMMARY OF THE DISCLOSURE

Accordingly, the present disclosure has been made keeping in mind the above problems occurring in the related art, and the present disclosure is intended to propose a frameless door for a vehicle, wherein in order to allow a glass run to be independently moved in contact with a moving glass as a window is opened, the glass run is divided into a bottom lip and an inner lip, and a support lip is added to the inner lip supporting an inner surface of the moving glass to elastically support the moving glass, so that water is prevented from flowing into a gap between the glass run and the moving glass in high-pressure car washing.

In order to achieve the above objective, according to one aspect of the present disclosure, there is provided a frameless door for a vehicle, the frameless door including: a fixed glass coupled to a door frame of a vehicle; an elastic member mounted to enclose an upper edge of the fixed glass; a glass run arranged between the fixed glass and a moving glass, and configured to guide upward movement of the moving glass, and configured to seal an inside space of the moving glass; and a division channel configured to accommodate the glass run therein, and configured to fix both the fixed glass and the glass run to the door frame.

In some embodiments, the elastic member may be made of thermos plastic elastomer (TPE) material.

In some embodiments, the glass run may be made of ethylene-propylene dine monomer (EPDM) material.

In some embodiments, the glass run may include: a bottom lip caught to and located at a first region partitioned in the division channel, and exposed to an outside space and arranged on the same level as the fixed glass and the moving glass, and configured to support the raised moving glass; and an inner lip caught to and located at a second region provided adjacent to the first region, and configured to elastically support the raised moving glass together with the bottom lip.

In some embodiments, the bottom lip may have different hardness and physical property from the inner lip. In some embodiments, the bottom lip may have stronger hardness and more solid property than the inner lip.

In some embodiments, the inner lip may include: a first support lip configured to elastically support an inner surface of the moving glass while a side surface of the moving glass is elastically supported by the bottom lip; and a second support lip arranged to be spaced apart from the first support lip and configured to elastically support the inner surface of the moving glass, and arranged at an angle opposite to the bottom lip.

In some embodiments, the second support lip may have a rounded outer surface facing the inner surface of the moving glass.

In some embodiments, the bottom lip may include: a first support lip configured to elastically support a side surface of the moving glass while an inner surface of the moving glass may be elastically supported to the inner lip; and a second support lip arranged to be spaced apart from the first support lip and configured to elastically support the inner surface of the moving glass, and arranged at an angle opposite to the first support lip.

In some embodiments, the second support lip may have a rounded outer surface facing the inner surface of the moving glass.

In some embodiments, the frameless door may include: a rail member vertically coupled to the fixed glass at a first side of the fixed glass, wherein the division channel may be coupled to the rail member in a rail manner together with the glass run, and be configured to slidingly move in a vertically direction to be mounted to the fixed glass.

According to the present disclosure, when the moving glass is brought into contact with the glass run in response to opening of the window, the glass run is divided into the bottom lip and the inner lip so that the glass run is independently movable, the moving glass. The additional lip is added to the inner lip supporting the inner surface of the moving glass to elastically support the moving glass, in a high-pressure car washing, so that it is possible to prevent leakage of water into a gap between the glass run and the moving glass, and watertight performance for the flameless door can be improved.

Then, the frameless door of the present disclosure is configured to preset different hardness and property to the bottom lip and the inner lip. Therefore, as the glass run is brought into contact with the moving glass, transmission of vibrations generated from the inner lip to the bottom lip is prevented in advance, so that movement stability of the moving glass can be secured.

Furthermore, in the frameless door of the present disclosure, the glass run located in the door frame is composed of the bottom lip and the inner lip integrally connected to each other like the conventional structure, thereby stably supporting the moving glass. Accordingly, in opening of the door, a problem such as shaking of the moving glass can be prevented.

In another embodiment, vehicles are provided that comprise an apparatus as disclosed herein.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a view schematically showing a structure of a frameless door for a vehicle according to the embodiment of the present disclosure.

FIG. 2 is a sectional view showing the frameless door for a vehicle according to the embodiment of the present disclosure, the view being taken along line A-A in FIG. 1.

FIG. 3 is a view showing the watertight structure of a glass run for the frameless door for a vehicle according to the embodiment of the present disclosure.

FIG. 4 is a view showing the watertight structure of a conventional glass run for the frameless door for a vehicle according to the embodiment of the present disclosure.

FIG. 5 is a view showing another embodiment of the glass run for the frameless door for a vehicle according to the embodiment of the present disclosure.

FIG. 6 is a view showing another embodiment of the glass run for the frameless door for a vehicle according to the embodiment of the present disclosure.

### DETAILED DESCRIPTION OF THE EMBODIMENTS

Hereinbelow, an exemplary embodiment of the present disclosure will be described in detail with reference to the accompanying drawings

The features and advantages of the present disclosure and method for achieving the features and advantages will be more clearly understood from the following detailed description when taken in conjunction with the accompanying drawings

However, the present disclosure is not limited to the following embodiments, is implemented as various forms. The embodiments of the present disclosure are presented to make complete disclosure of the present disclosure and help those who are ordinarily skilled in the art best understand the present disclosure. In addition, the scope of the present disclosure is defined only by the accompanying claims and their equivalents if appropriate.

Furthermore, in the following description of the present disclosure, detailed descriptions of known functions and configurations which are deemed to make the gist of the present disclosure obscure will be omitted.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-el”, “-or”, and “module” described in the specification mean units for processing at least one function and operation, and can be implemented by hardware components or software components and combinations thereof.

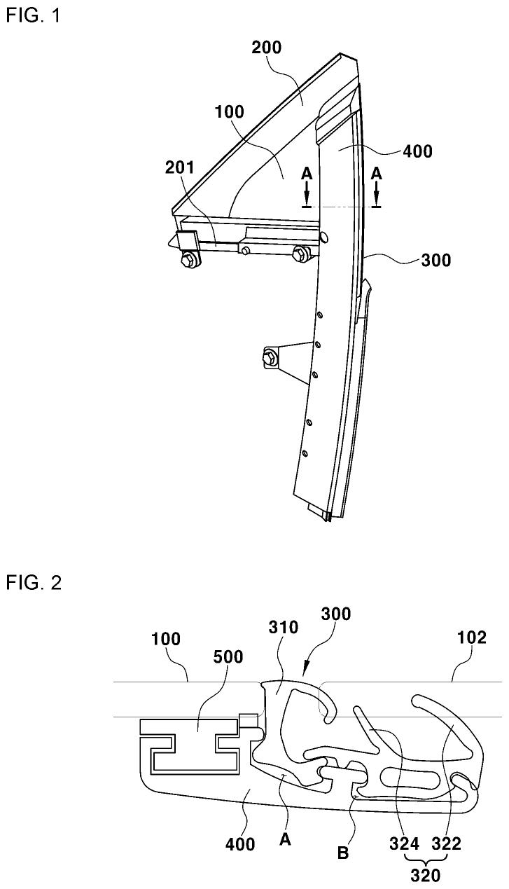

FIG. 1 is a view schematically showing a structure of a frameless door for a vehicle according to the embodiment of the present disclosure. FIG. 2 is a sectional view showing the frameless door for a vehicle according to the embodiment of the present disclosure, the view being taken along line A-A in FIG. 1.

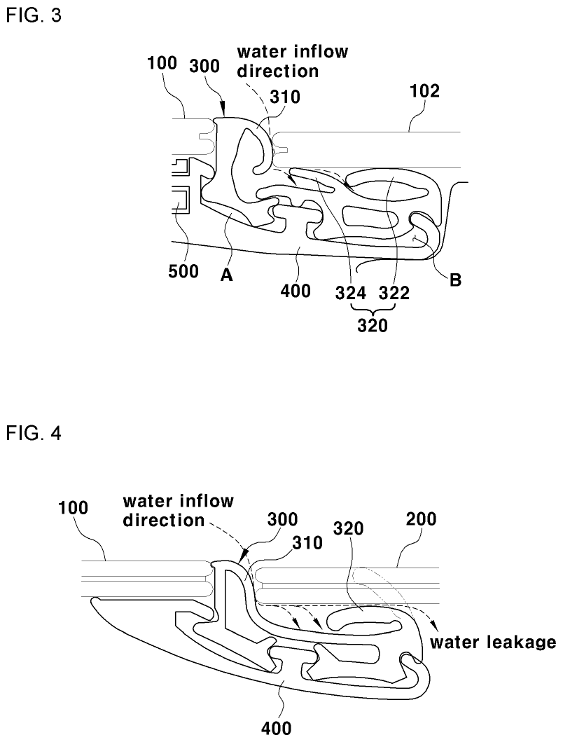

FIG. 3 is a view showing the watertight structure of a glass run for the frameless door for a vehicle according to the embodiment of the present disclosure. FIG. 4 is a view showing the watertight structure of a conventional glass run for the frameless door for a vehicle according to the embodiment of the present disclosure.

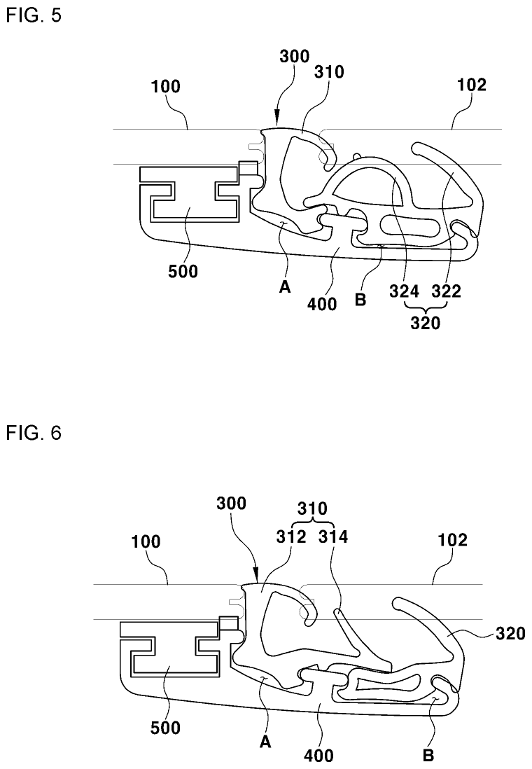

FIG. 5 is a view showing another embodiment of the glass run for the frameless door for a vehicle according to the embodiment of the present disclosure. FIG. 6 is a view showing another embodiment of the glass run for the frameless door for a vehicle according to the embodiment of the present disclosure.

As shown in FIG. 1, according to the embodiment of the present disclosure, the frameless door for a vehicle may include a fixed glass 100, an elastic member 200, a glass run 300, and a division channel 400.

Normally, a vehicle is equipped with a door frame constituting a door, and a moving glass 102 and a window regulator motor (not shown) provided to move the moving glass 102 to reciprocate in a vertical direction are provided and coupled to the inner space of the door frame.

Furthermore, as described above, at a front portion of the door frame with the moving glass 102, i.e., at an A pillar, the fixed glass 100 may be securely coupled. The fixed glass 100 may be fixed to be immobilized different from the moving glass 102.

The elastic member 200 may be made of a material such as rubber, etc., and is mounted to enclose an upper edge of the fixed glass 100.

The elastic member 200 is preferably made of thermo plastic elastomer (TPE) material that has excellent properties such as resilience and shock absorption for a state where the fixed glass 100 and a body-side weatherstrip are brought into close contact with each other in closing of the door frame.

The glass run 300 may be configured to guide upward movement of the moving glass 102 with respect to the fixed glass 100, and preferably, is made of ethylene-propylene diene monomer (EPDM) material.

As shown in FIG. 2, the glass run 300 may be arranged between the fixed glass 100 and the moving glass 102 to be in close contact with each of the glasses to seal the inner space of the moving glass 102, thereby preventing fluid such as water from flowing into the inner space of the moving glass from the outer space.

Accordingly, in order to maximize watertight performance and improve movement performance of the window glass, a glass run 300 may be provided by being divided into the bottom lip 310 and an inner lip 320.

A bottom lip 310 may be caught to and located in a first region A while being inserted into the first region A partitioned inside the division channel 400.

Then, the bottom lip 310 may be formed in a′ C′ shape and is exposed outward. Specifically, the bottom lip 310 is arranged on the same level as the fixed glass 100 and the moving glass 102 and one portion thereof is exposed outward, so that gap between the fixed glass 100 and the moving glass 102 may be efficiently sealed. Moreover, the bottom lip 310 implements a zero step structure between the fixed glass 100 and the moving glass 102, thereby satisfying the design element for the frameless door.

Preferably, the bottom lip 310 may be formed to have the hardness and physical property different from the inner lip 320, and more preferably, the bottom lip 310 may be formed to have the stronger hardness and more solid property in comparison to the inner lip 320.

Comparing the inner lip 320 to the bottom lip 310, since the inner lip 320 may have a structure supporting the moving glass 102 when the moving glass 102 is raised, the inner lip 320 is formed to have the week hardness and soft physical property compared to the bottom lip 310. Therefore, vibrations and noise generated as the moving glass 102 is raised is reduced by the above configuration of the bottom lip.

The inner lip 320 may be caught to and located in a second region B located adjacent to the first region A, and elastically support the moving glass 102 together with the bottom lip 310.

While the bottom lip 310 supports a side surface of the moving glass 102, the inner lip 320 may be provided to elastically support an inner surface of the moving glass 102 by the structure separated from the bottom lip 310. Accordingly, the inner lip 320 may move separately from the bottom lip 310.

Conventionally, as shown in FIG. 4, the bottom lip 310 and the inner lip 320 may be integrally provided, so that the bottom lip 310 is compressed in upward movement of the moving glass 102. In the above state, vibrations are generated in the inner lip 320, and thus the generated vibrations are transmitted to the bottom lip 310 in response to the structural property, so that noise may be caused by the vibrations of the bottom lip 310.

Therefore, in the embodiment, the glass run 300 may be divided into the bottom lip 310 and the inner lip 320, and separate movements of the bottom lip 310 and the inner lip 320 may be possible when the bottom lip 310 and the inner lip 320 are brought into contact with the moving glass 102 in response to upward movement of the moving glass 102, thereby preventing a problem as described above in advance.

Then, the inner lip 320 may include a first support lip 322 and an additional second support lip 324 in order to the watertight performance for the inside region of the moving glass 102.

First, the first support lip 322 may be configured to elastically support the inner surface of the moving glass 102 while the side surface of the moving glass 102 is elastically supported by the bottom lip 310.

The second support lip 324 may be arranged to be spaced apart from the first support lip 322 to elastically support the inner surface of the moving glass 102. The second support lip 324 is formed at an angle of a direction opposite to the bottom lip 310, more specifically, the second support lip 324 is formed at an angle opposite to a bent angle based on a state where the bottom lip 310 is bent to be rounded in an inward direction while supporting the inner surface of the moving glass 102. When the second support lip 324 is in close contact with the moving glass 102, the second support lip 324 allows an elastic force to be applied in a close contact direction (referring to FIG. 2), so that watertight performance for the inside space of the moving glass 102 can be secured.

Therefore, as shown in FIG. 3, in a situation such as car washing, when a flow of the moving glass 102 is generated by high pressure water, the water may be introduced in a direction of the arrow in FIG. 3, water introduction is prevented first by an elastic force generated in a spread direction in the rounded bent structure of the bottom lip 310. However, even when the water is introduced into a gap between the side surface of the moving glass 102 and the bottom lip 310, the inner surface of the moving glass 102 may be elastically supported secondary and tertiary by the first support lip 322 and the second support lip 324 formed with the above-described structure, so that watertight for the inside region of the moving glass 102 can be secured.

In addition, as described above, since the inner lip 320 may be separately movable from the bottom lip 310, the conventional problem in that it is difficult to secure watertight for the inside region of the moving glass 102 by movement of the bottom lip 310 can be prevented.

In other words, conventionally, as shown in FIG. 4, as the moving glass 102 is raised while being in contact with the bottom lip 310, the form of the bottom lip may be changed. Thus, the form of the inner lip 320 is also changed, and leakage toward the indoor space of the vehicle may occur. However, in the embodiment, with the property of the bottom lip 310 and the inner lip 320 that are separately moved from each other, the above-described problem can be prevented in advance.

Meanwhile, the second support lip 324 may have a predetermined inside space as shown in FIG. 5, and an outer surface of the predetermined inside space is rounded, thereby facing the inner surface of the moving glass 102.

Since the second support lip 324 may be damaged by wear as the moving glass 102 is repeatedly raised and lowered, the second support lip 324 may be configured to support the inner surface of the moving glass 102 with relatively wider area in the above-described embodiment, so that watertight performance may be maintained more robustly.

Otherwise, as shown in FIG. 6, the bottom lip 310 may have a structure consisting of a first support lip 312 and a second support lip 314, and the single inner lip 320 in the same way that the inner lip 320 consists of the first support lip 322 and the second support lip 324.

Herein, the first support lip 312 may have the same structure and functional property as the first support lip 322 in the above-described embodiment, and the second support lip 314 has the same structure and functional property as the second support lip 324 in the above-described embodiment, so the separate detailed description thereof will be omitted.

Then, although not shown in the drawings, the second support lip 314 may have a predetermined inside space equal to the above-described embodiment, and an outer surface of the predetermined inside space is formed to be rounded and may face the inner surface of the moving glass 102.

In the above structure, the second support lip 314 may have a predetermined inner space, and an outer surface of the predetermined inner space may be formed to be rounded and may face the inner surface of the moving glass 102 (referring to FIG. 5). Since the second support lip 314 may be damaged by wear as the moving glass 102 is repeatedly raised and lowered, the second support lip 314 may be configured to support the inner surface of the moving glass 102 with a relatively wider area in the above-described embodiment, so that watertight performance can be maintained more robustly.

In the embodiment, since the bottom lip 310 may have stronger hardness and more solid physical property compared to the inner lip 320, the above-structure may be used in order to stably support the moving glass 102. As a result, considering the property of supporting the moving glass 102, the bottom lip 310 may be selectively provided or the inner lip 320 is selectively provided.

Although not shown in the drawings, a lower region of the glass run 300 which is located in the door frame and exposed outward may have the structure in which the bottom lip 310 and the inner lip 320 are integrated equal to the conventional structure (referring to FIG. 4). Accordingly, the moving glass 102 is stably supported in opening and closing a door, thereby preventing problems such as shaking of the moving glass 102 in advance.

Meanwhile, the division channel 400 may support a raised located of the moving glass 102 when the moving glass 102 is raised, and is configured to secure watertight and indoor soundproof performance. Therefore, the division channel 400 accommodates the glass run 300 therein and is slidingly moved in a vertical direction to fix the fixed glass 100 to the door frame.

The division channel 400 may be coupled to the fixed glass 100 by being pushed in the vertical direction, i.e., a bottom to top direction at one portion of the fixed glass 100, while a rail member 500 has been located in the division channel 400.

In other words, the H-shaped rail member 500 may be coupled to the one portion of the fixed glass 100 in the vertical direction (referring to FIG. 2), and while the fixed glass 100, the rail member 500, a plurality of brackets B and the glass run 300 are integrally placed on an injection molding, a plurality of elastic members 200 and 201 may be molded to the fixed glass 100 and manufactured as a fixed glass product to be mounted to the door frame. Herein, the division channel 400 pushes the glass run 300 while the glass run 300 is inserted in the division channel 400, and the rail member 500 may also is inserted into at a predetermined location of the division channel 400, thereby being mounted to the fixed glass product in a rail coupling method.

According to the present disclosure, when the moving glass is brought into contact with the glass run in response to opening of the window, the glass run may be divided into the bottom lip and the inner lip so that the glass run is independently movable, the moving glass. The additional lip is added to the inner lip supporting the inner surface of the moving glass to elastically support the moving glass, in a high-pressure car washing, so that it is possible to prevent leakage of water into a gap between the glass run and the moving glass, and watertight performance for the flameless door can be improved.

Then, the frameless door of the present disclosure may be configured to preset different hardness and property to the bottom lip and the inner lip. Therefore, as the glass run is brought into contact with the moving glass, transmission of vibrations generated from the inner lip to the bottom lip is prevented in advance, so that movement stability of the moving glass can be secured.

Furthermore, in the frameless door of the present disclosure, the glass run located in the door frame may be composed of the bottom lip and the inner lip integrally connected to each other like the conventional structure, thereby stably supporting the moving glass. Accordingly, in opening of the door, a problem such as shaking of the moving glass can be prevented.

Although the preferred embodiment(s) of the present disclosure has been disclosed for illustrative purposes, those skilled in the art will appreciate that various modifications, additions and substitutions are possible, without departing from the scope and spirit of the present disclosure as disclosed in the accompanying claims, and it will be appreciated that all or part of the embodiment(s) described above may optionally be combined to constitute the present disclosure. Therefore, the technical protection scope of the present disclosure should be determined by the technical idea of the accompanying claims.

What is claimed is:

1. A frameless door for a vehicle, the frameless door comprising:
a fixed glass coupled to a door frame of a vehicle;
an elastic member mounted to enclose an upper edge of the fixed glass;
a glass run arranged between the fixed glass and a moving glass, and configured to guide upward movement of the moving glass, and configured to seal an inside space of the moving glass; and
a division channel configured to accommodate the glass run therein, and configured to fix both the fixed glass and the glass run to the door frame.

2. The frameless door of claim 1, wherein the glass run comprises:
a bottom lip caught to and located at a first region partitioned in the division channel, and exposed to an outside space and arranged on the same level as the fixed glass and the moving glass, and configured to support the raised moving glass.

3. The frameless door of claim 2, wherein the glass run further comprises:
an inner lip caught to and located at a second region provided adjacent to the first region, and configured to elastically support the raised moving glass together with the bottom lip.

4. The frameless door of claim 3, wherein the bottom lip has different hardness and physical property from the inner lip.

5. The frameless door of claim 4, wherein the bottom lip has stronger hardness and more solid property than the inner lip.

6. The frameless door of claim 3, wherein the inner lip comprises:
a first support lip configured to elastically support an inner surface of the moving glass while a side surface of the moving glass is elastically supported by the bottom lip.

7. The frameless door of claim 6, wherein the inner lip further comprises:
a second support lip arranged to be spaced apart from the first support lip and configured to elastically support the inner surface of the moving glass, and arranged at an angle opposite to the bottom lip.

8. The frameless door of claim 7, wherein the second support lip has a rounded outer surface facing the inner surface of the moving glass.

9. The frameless door of claim 3, wherein the bottom lip comprises:
a first support lip configured to elastically support a side surface of the moving glass while an inner surface of the moving glass is elastically supported to the inner lip.

10. The frameless door of claim 9, wherein the bottom lip further comprises:
a second support lip arranged to be spaced apart from the first support lip and configured to elastically support the inner surface of the moving glass, and arranged at an angle opposite to the first support lip.

11. The frameless door of claim 10, wherein the second support lip has a rounded outer surface facing the inner surface of the moving glass.

12. The frameless door of claim 1, further comprising:
a rail member vertically coupled to the fixed glass at a first side of the fixed glass,
wherein the division channel is coupled to the rail member in a rail manner together with the glass run, and is configured to slidingly move in a vertically direction to be mounted to the fixed glass.

13. The frameless door of claim 1, wherein the elastic member is made of thermos plastic elastomer (TPE) material.

14. The frameless door of claim 1, wherein the glass run is made of ethylene-propylene dine monomer (EPDM) material.

15. A vehicle comprising the frameless door of claim 1.
